(19) United States
(12) Patent Application Publication
(10) Pub. No.: US 2018/0191940 A1
(43) Pub. Date: Jul. 5, 2018

(54) IMAGE CAPTURING DEVICE AND CONTROL METHOD THEREOF

(71) Applicant: Altek Semiconductor Corp., Hsinchu City (TW)

(72) Inventors: Chien-Hsiu Wu, Hsinchu City (TW); Shuei-Lin Chen, Hsinchu City (TW)

(73) Assignee: Altek Semiconductor Corp., Hsinchu City (TW)

(21) Appl. No.: 15/484,147

(22) Filed: Apr. 11, 2017

(30) Foreign Application Priority Data
Dec. 30, 2016 (TW) 105144044

(51) Int. Cl. H04N 5/232; H04N 7/18

(52) U.S. Cl. CPC H04N 5/23203; H04N 7/181

(57) ABSTRACT

An image capturing device and a control method thereof are disclosed, where the image capturing device includes a main controller, a primary camera, and at least one secondary camera. The primary camera receives a primary photographing parameter setting from the main controller via a primary control interface. The secondary camera obtains the primary photographing parameter setting from the primary camera through a secondary control interface to accordingly generate a secondary photographing parameter setting. The primary camera and the secondary camera respectively perform image capturing by using the primary photographing parameter setting and the secondary photographing parameter setting to respectively generate primary image data and secondary image data. The secondary camera transmits the secondary image data to the primary camera via a secondary image interface, and the primary camera transmits the primary image data and the secondary image data to the main controller via a primary image interface.

### CROSS-REFERENCE TO RELATED APPLICATION

This application claims the priority benefit of Taiwan application serial no. 105144044, filed on Dec. 30, 2016. The entirety of the above-mentioned patent application is hereby incorporated by reference herein and made a part of this specification.

### TECHNICAL FIELD

The disclosure relates to an image capturing device and a control method thereof, in particular, to an image capturing device having multiple cameras and a control method thereof.

### BACKGROUND

With development in technology, various smart image capturing devices, such as tablet computers, personal digital assistants and smart phones, have become indispensable tools for people nowadays. Camera lenses equipped in high-end smart mobile image capturing devices provide same or better specifications than those of traditional consumer cameras, and some even provide three-dimensional image capturing features or near-equivalent pixel qualities to those of digital single lens reflex cameras.

In terms of an image capturing device with two cameras, the existing main controller would mainly control the two cameras via an inter integrated circuit (I2C) or a serial peripheral interface (SPI), where the main controller could be connected to a single or multiple sets of I2C or SPI depending on system requirements. Next, images captured by the two cameras would be transmitted to the main controller through their respective mobile industry processor interfaces (MIPI), transmitted to the main controller in turn through a switch additionally disposed between the two cameras and the main controller, or combined into a single image for transmission.

However, the existing system architecture would transmit related or duplicate control settings to different cameras with significant system resources which cause burden to the main controller. Moreover, software versions for different cameras would be customized and thereby raise difficulties in design and cost control. When the main controller needs to receive original image data from different cameras at the same time, different MIPI interfaces would be turned on for one-on-one reception. To maintain the high-speed transmission requirement on MIPI, difficulties in design and limitations in application would be inevitably presented.

### SUMMARY OF THE DISCLOSURE

Accordingly, an image capturing device and a control method thereof are provided in the disclosure, where the specification of the control interfaces and the image transmission interfaces of the multiple cameras would be simplified to reduce the burden of the main controller as well as to reduce the space occupied in circuit board layout, and the manufacturing cost would be thus significantly lower.

According to one of the exemplary embodiments, the image capturing device includes a main controller, a primary camera, and at least one secondary camera, where the primary camera is coupled to the main controller and the secondary camera. The primary camera receives a primary photographing parameter setting from the main controller via a primary control interface. The secondary camera obtains the primary photographing parameter setting from the primary camera via a secondary control interface to accordingly generate a secondary photographing parameter setting. The primary camera and the secondary camera respectively perform image capturing by using the primary photographing parameter setting and the secondary photographing parameter setting to respectively generate primary image data and secondary image data. The secondary camera transmits the secondary image data to the primary camera via a secondary image interface, and the primary camera transmits the primary image data and the secondary image data to the main controller via a primary image interface.

According to one of the exemplary embodiments, the control method is adapted to the image capturing device having multiple cameras and a main controller, where the cameras include a primary camera and at least one secondary camera. The control method includes the following steps. A primary photographing parameter setting associated with the primary camera is received by the primary camera from the main controller via a primary control interface. The primary photographing parameter setting is obtained by the secondary control interface from the primary camera via a secondary control interface to accordingly generate a secondary photographing parameter setting. Image capturing is performed by using the primary photographing parameter setting and the secondary photographing parameter setting respectively by the primary camera and the secondary camera to generate primary image data and secondary image data. The secondary image data is transmitted to the primary camera by the secondary camera via a secondary image interface, and the primary image data and the secondary image data are transmitted to the main controller by the primary camera via a primary image interface.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a block diagram of a proposed image capturing device in accordance with one of the exemplary embodiments of the disclosure.

FIG. 2 illustrates a flowchart of a control method of an image capturing device in accordance with one of the exemplary embodiments of the disclosure.

FIG. 3 illustrates a schematic dataflow diagram of a control method of an image capturing device in accordance with one of the exemplary embodiments of the disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

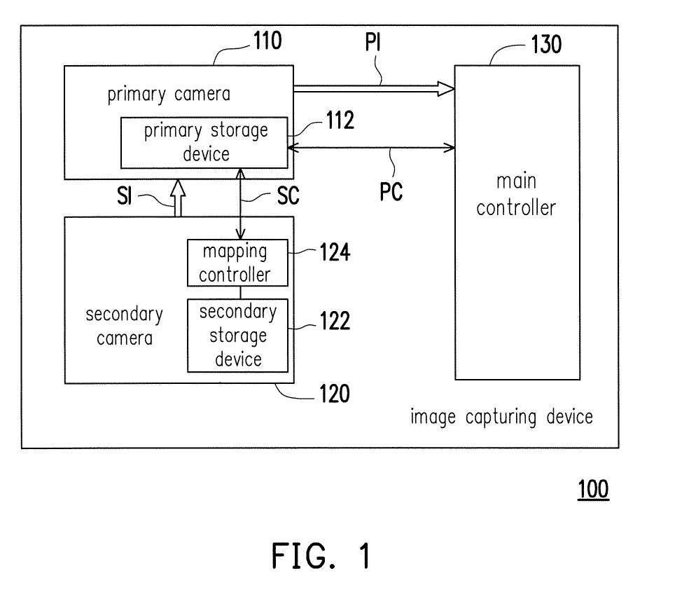

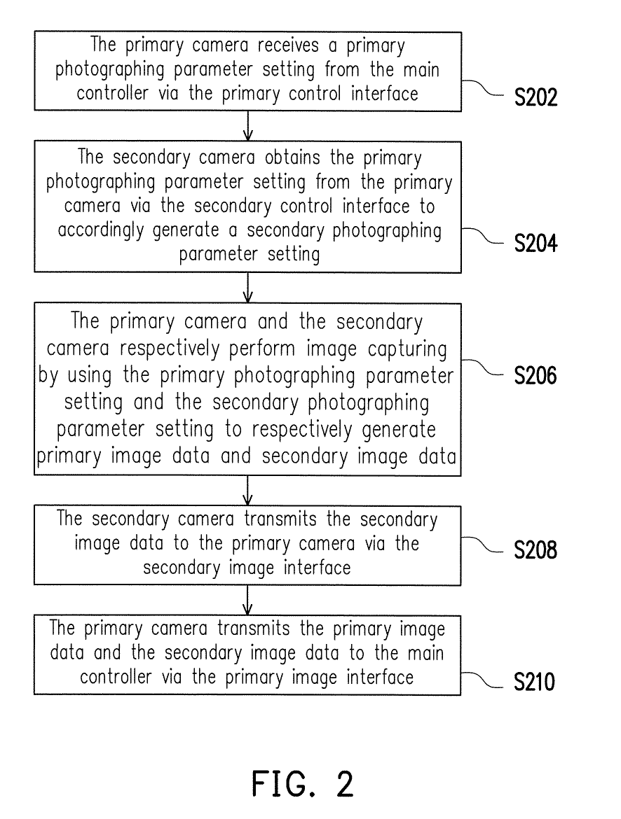

FIG. 1 illustrates a schematic diagram of a proposed image capturing device in accordance with one of the exemplary embodiments of the disclosure. All components of the image capturing device and their configurations are first introduced in FIG. 1. The functionalities of the components are disclosed in more detail in conjunction with FIG. 2.

Referring to FIG. 1, an image capturing device 100 would include a primary camera 110, a secondary camera 120, and a main controller 130, where the primary camera 110 is connected to the secondary camera 120 and the main controller 130.

The primary camera 110 and the secondary camera 120 include lenses and sensing elements. The sensing elements are configured to sense light intensity entering the lenses to thereby generate images and may be, for example, charge-coupled-device (CCD) elements, complementary metal-oxide semiconductor (CMOS) elements. In the present exemplary embodiment, the primary camera 110 and the secondary camera 120 may have the same resolution and the same optical characteristics. However, in other exemplary embodiments, the primary camera 110 and the secondary camera 120 may have different resolutions or different optical characteristics such as focal lengths, sensing sizes, distortion levels, mono or color sensitivity.

The main controller 130 may be, for example, a central processing unit (CPU) or other programmable devices for general purpose or special purpose such as a microprocessor and a digital signal processor (DSP), a programmable controller, an application specific integrated circuit (ASIC), a programmable logic device (PLD), other similar devices or a combination of above-mentioned devices.

In the present exemplary embodiment, the primary camera 110 would be connected to the main controller 130 via a primary control interface PC to perform two-way signal transmission. Moreover, the secondary camera 120 would be connected to the primary camera 110 via a secondary control interface SC to perform two-way signal transmission. Herein, the primary control interface PC and the secondary control interface SC may meet an inter integrated circuit (I2C) protocol standard.

On the other hand, the primary camera 110 would be connected to the main controller 130 via a primary image interface PI to perform image data transmission. Moreover, the secondary camera 120 would be connected to the primary camera 110 via a secondary image interface SI to perform image data transmission. Herein, the primary image interface PI and the secondary image interface SI may meet a mobile industry processor interface (MIPI) protocol standard.

The primary camera 110 and the secondary camera 120 would respectively include storage devices (referred to as “a primary storage device 112” and “a secondary storage device 122”). The primary storage device 112 and the secondary storage device 122 may be registers configured to temporarily store data such as instructions and settings. Moreover, the secondary camera 120 would further include a mapping controller 124 coupled to the storage device 122. The mapping controller 124 may be, for example, a programmable controller or integrated circuits that would be configured to read, map, and write data.

Detailed steps of the control method of the image capturing device 100 would be illustrated along with each component of the electronic device 100 hereafter.

FIG. 2 illustrates a flowchart of a control method of an image capturing device in accordance with one of the exemplary embodiments of the disclosure.

Referring to FIG. 2 in conjunction with FIG. 1, before the image capturing device 100 performs image capturing on a scene, the main controller 130 would detect the scene by using the primary camera 110 to generate a photographing parameter setting (referred to as “a primary photographing parameter setting” hereafter) for the primary camera 110 to capture the scene. The primary photographing parameter setting may be, for example, initialization, image output specification, focus, exposure, white balance, and so forth. Next, the primary camera 110 would receive the primary photographing parameter setting from the main controller 130 via the primary control interface PC (Step S202) and write the primary photographing parameter setting into associated address space in the primary storage device 112.

On the other hand, the secondary camera 120 would obtain the primary photographing parameter setting from the primary camera 110 via the secondary control interface SC to accordingly generate a secondary photographing parameter setting (Step S204). In the present exemplary embodiment, the mapping controller 124 of the secondary camera 120 may monitor whether a write-in operation of the primary photographing parameter setting is performed on the primary storage device 112 of the primary camera 110 via the secondary control interface SC. If yes, the mapping controller 124 would then obtain the primary photographing parameter setting from the primary storage device 112.

Since there may exist differences between the secondary camera 120 and the primary camera 110 in terms of specifications and characteristics, after the mapping controller 124 obtains the primary photographing parameter setting, it would convert the primary photographing parameter setting to the secondary photographing parameter setting according to a preset primary-secondary camera mapping table and write the secondary photographing parameter setting into the secondary storage device 122. The primary-secondary camera mapping table may be a mapping table generated according to differences between the primary camera 110 and the secondary camera 120 during the manufacturing stage. For example, assume that there exist differences in luminous sensitivity between the two cameras, and then the primary-secondary camera mapping table may store luminance gain ratios. Accordingly, the main controller 130 would only need to set a photographing parameter of the primary camera 110, and the secondary camera 120 would set its own photographing parameter according to the primary photographing parameter setting based on the primary-secondary camera mapping table.

Next, the primary camera 110 and the secondary camera 120 would respectively perform image capturing by using the primary photographing parameter setting and the secondary photographing parameter setting to respectively generate primary image data and secondary image data (Step S206). In the present exemplary embodiment, the primary camera 110 and the secondary camera 120 may perform image capturing synchronously by using the primary photographing parameter setting and the secondary photographing parameter setting according to a synchronization signal so as to respectively generate the primary image data and the secondary image data. Next, the secondary camera 120 would transmit the secondary image data to the primary camera 110 via the secondary image interface SI (Step S208), and the primary camera 110 would transmit the primary image data and the secondary image data to the main controller 130 via the primary image interface PI (Step S210). Herein, the primary camera 110 would concurrently transmit the primary image data and the secondary image data to the main controller 130 via the same primary image interface PI through virtual channels or data types for the follow-up image processing procedures.

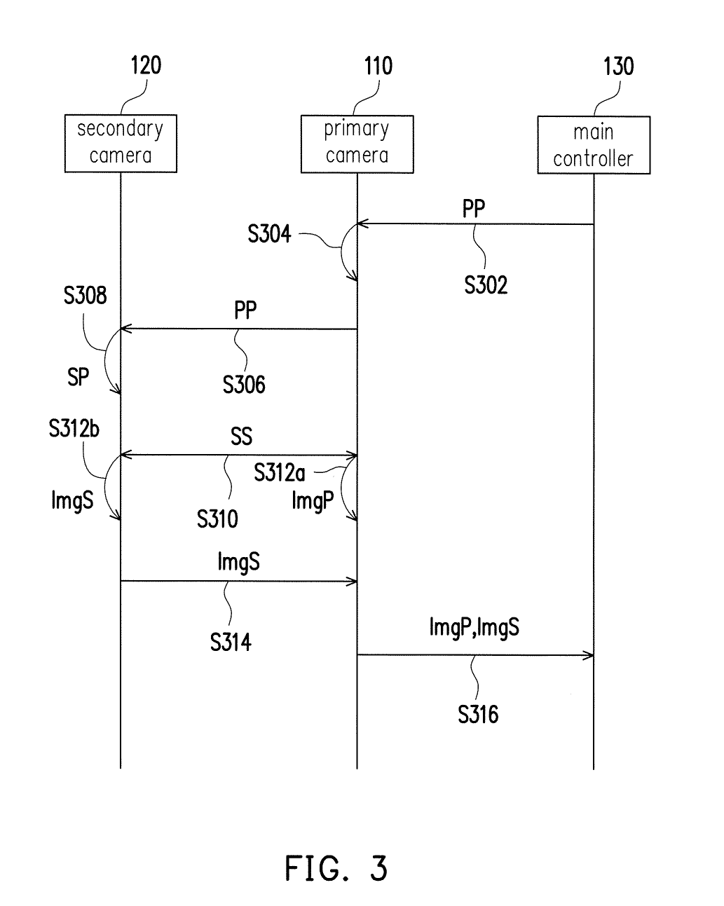

FIG. 3 illustrates a schematic data flow diagram of a control method of an image capturing device in accordance with one of the exemplary embodiments of the disclosure.

Referring to FIG. 3 in conjunction with FIG. 1, before the image capturing device 100 performs image capturing on a scene, the main controller 130 would transmit a main photographing parameter setting PP to the primary camera 110 (Dataflow S302), and the primary camera 110 would write the main photographing parameter setting PP into the primary storage device 112 (Dataflow S304). Meanwhile, the secondary camera 120 would obtain main photographing parameter setting PP from the primary storage device 112 of the primary camera 110 (Dataflow S306) to accordingly generate a secondary photographing parameter setting SP (Dataflow S308). Next, the primary camera 110 and the secondary camera 120 would respectively perform image capturing by using the primary photographing parameter setting and the secondary photographing parameter setting to respectively generate primary image data ImgP and secondary image data ImgS (Dataflow S312a, S312b). Next, the secondary camera 120 would transmit the secondary image data ImgS to the primary camera 110 (Dataflow S314), and the primary camera 110 would next transmit the primary image data ImgP and the secondary image data ImgS to the main controller 130 (Dataflow S316) for the follow-up image processing procedures. Detailed steps of FIG. 3 may refer to the related description in FIG. 2 and would not be repeated herein.

It should be noted that, the applications of the primary camera 110 and the secondary camera 120 of the image capturing device 100 may be a combination of a color camera and a mono camera, a combination of zoom cameras (with different field of views or different resolutions), and a combination of a large camera and a small camera as listed in Table 1. In the related applications of Table 1, the primary image interface PI and the secondary image interface SI may be MIPI, the primary control interface PC and the secondary control interface SC may be I2C, and the man controller may be an application processor (AP).

TABLE 1

| | | Dual Zoom Cameras | |
|---|---|---|---|
| | Color Camera | (with different FOV/ | Large Camera |
| Specification | Mono Camera | different resolutions) | Small Camera |
| MIPI Tx | Single | Single | Single |
| (to AP) | (primary camera only) | (primary camera only) | (primary camera only) |
| MIPI virtual | Yes | No | Yes |
| channels to | | | |
| output secondary | | | |
| image data | | | |
| MIPI switch | No | Yes | No |
| (auto) | | | |
| I2C | Single | Single | Single |
| (to AP) | (primary camera only) | (primary camera only) | (primary camera only) |
| I2C | Yes | Yes | Yes |
| (between cameras) | | | |
| Register write-in | Primary: write in directly | | |
| | Secondary: written in by a mapper controller | | |
| Register read | Able to read the register of either the primary camera or the secondary camera | | |
| Frame | Both cameras are | Both cameras are | Both cameras are |
| Synchronization | synchronized based | synchronized based on | synchronized based |
| | on synchronization | synchronization signal | on synchronization |
| | signal. | OR | signal. |
| | | One camera active and | |
| | | one camera standby | |
| Low Latency | No | Yes | No |
| Wakeup | | | |
| Dual-stream Output | Yes | Yes | Yes |

The image capturing device 100 in the aforementioned exemplary embodiments may be extended to include two or more secondary cameras. That is, in another exemplary embodiment, others secondary cameras may be added and each of which may be connected to the primary camera 110 via its own secondary image interface and secondary control interface. Similarly, the main controller 130 would only set a photographing parameter for the primary camera 110, and each of the secondary cameras would set its own photographing parameter according to the primary photographing parameter setting and its own primary-secondary camera mapping table. After the primary camera 110 and the secondary cameras generate primary image data and secondary image data, the primary camera 110 would transmitted the primary image data and the secondary image data to the main controller 130 via different virtual channels of the single primary image interface PI for the follow-up image processing procedures.

In summary, in the image capturing device and its control method proposed in the disclosure, the main controller would only set a photographing parameter for a single primary camera, and the secondary cameras would set their own photographing parameters according to the photographing parameter of the primary camera and their respective primary-secondary camera mapping table. Hence, the specification of the control interfaces and the image transmission interfaces of the multiple cameras would be simplified to reduce the burden of the main controller as well as the space occupied by microstrip lines in circuit board layout, and the manufacturing cost would be thus significantly lower. Moreover, the simplified interface would provide a shared motherboard or shared software version in single-camera or multi-cameras applications so that different targeting products could be provided to the market through combinations of different types of cameras.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An image capturing device comprising:
a main controller;
a plurality of cameras comprising:
a primary camera, coupled to the main controller and comprising a primary storage device, wherein the primary camera performs transmission with the main controller via a primary control interface and a primary image interface; and
at least one secondary camera, comprising a secondary storage device and a mapping controller, wherein the secondary camera perform transmission with the primary camera via a secondary control interface and a secondary image interface,
wherein the primary camera receives a primary photographing parameter setting associated with the primary camera from the main controller via the primary control interface,
wherein the secondary camera obtains the primary photographing parameter setting associated with the secondary camera from the primary camera via the secondary control interface to accordingly generate a secondary photographing parameter setting,
wherein the primary camera and the secondary camera respectively perform image capturing by using the primary photographing parameter setting and the secondary photographing parameter setting to respectively generate primary image data and secondary image data,
wherein the secondary camera transmits the secondary image data to the primary camera via the secondary image interface, and
wherein the primary camera transmits the primary image data and the secondary image data to the main controller via the primary image interface.

2. The image capturing device according to claim 1, wherein the primary camera writes the primary photographing parameter setting into the primary storage device, and wherein the secondary camera reads the primary photographing parameter setting from the primary storage device via the secondary control interface.

3. The image capturing device according to claim 1, wherein the mapping controller converts the primary photographing parameter setting to the secondary photographing parameter setting according to a primary-secondary camera mapping table and writes the secondary photographing parameter setting into the secondary storage device.

4. The image capturing device according to claim 1, wherein the primary camera and the secondary camera perform image capturing synchronously by using the primary photographing parameter setting and the secondary photographing parameter setting according to a synchronization signal so as to respectively generate the primary image data and the secondary image data.

5. The image capturing device according to claim 1, wherein the primary image interface comprises a plurality of virtual channels, and wherein the primary camera transmits the primary image data and the secondary image data to the main controller via the different virtual channels respectively.

6. The image capturing device according to claim 1, wherein the primary control interface and the secondary control interface meet an inter integrated circuit (I2C) protocol standard.

7. The image capturing device according to claim 1, wherein the primary control interface and the secondary control interface meet a mobile industry processor interface (MIPI) protocol standard.

8. The image capturing device according to claim 1, wherein the primary camera and the secondary camera is a combination of a color camera and a mono camera.

9. The image capturing device according to claim 1, wherein the primary camera and the secondary camera is a combination of zoom cameras with different field of views or different resolutions.

10. The image capturing device according to claim 1, wherein the primary camera and the secondary camera is a combination of a large camera and a small camera.

11. A control method of an image capturing device having a plurality of cameras and a main controller, wherein the cameras comprise a primary camera and at least one secondary camera, and wherein the control method comprises:
receiving a primary photographing parameter setting associated with the primary camera by the primary camera from the main controller via a primary control interface;
obtaining the primary photographing parameter setting by the secondary camera from the primary camera via a secondary control interface to accordingly generate a secondary photographing parameter setting associated with the secondary camera;
performing image capturing by using the primary photographing parameter setting and the secondary photographing parameter setting respectively by the primary camera and the secondary camera to generate primary image data and secondary image data;
transmitting the secondary image data to the primary camera by the secondary camera via a secondary image interface; and
transmitting the primary image data and the secondary image data to the main controller by the primary camera via a primary image interface.

12. The control method according to claim 11, wherein after the step of receiving the primary photographing parameter setting associated with the primary camera by the primary camera from the main controller via the primary control interface, the control method further comprises:
writing the primary photographing parameter setting into a primary storage device of the primary camera by the primary camera.

13. The control method according to claim 12, wherein the step of obtaining the primary photographing parameter setting by the secondary control interface from the primary camera via the secondary control interface comprises:
reading the primary photographing parameter setting from the primary storage device by the secondary camera via the secondary control interface.

14. The control method according to claim 11, wherein the step of generating the primary image data and the secondary image data comprises:
converting the primary photographing parameter setting to the secondary photographing parameter setting by the secondary camera according to a primary-secondary camera mapping table.

15. The control method according to claim 11, wherein after the step of generating the primary image data and the secondary image data, the control method further comprises:
writing the secondary photographing parameter setting into a secondary storage device of the secondary camera by the secondary camera.

16. The control method according to claim 11, wherein the step of performing image capturing by using the primary photographing parameter setting and the secondary photographing parameter setting respectively by the primary camera and the secondary camera to generate the primary image data and the secondary image data further comprising:
performing image capturing synchronously by the primary camera and the secondary camera by using the primary photographing parameter setting and the secondary photographing parameter setting according to a synchronization signal so as to respectively generate the primary image data and the secondary image data.

17. The control method according to claim 11, wherein the primary image interface comprises a plurality of virtual channels, and wherein the step of transmitting the primary image data and the secondary image data to the main controller by the primary camera via the primary image interface comprises:
transmitting the primary image data and the secondary image data to the main controller by the primary camera via the different virtual channels respectively.
